(19) United States
(12) Patent Application Publication
(10) Pub. No.: US 2013/0199375 A1
(43) Pub. Date: Aug. 8, 2013

(54) AIR FILTER WITH AIR FRESHENER

(71) Applicant: Bob Wheeler, Porter, TX (US)

(72) Inventor: Bob Wheeler, Porter, TX (US)

(21) Appl. No.: 13/366,741

(22) Filed: Feb. 6, 2012

(51) Int. Cl. B01D 39/16

(52) U.S. Cl. 96/222

(57) ABSTRACT

The present invention is an air filter that includes a first filter layer that catches a plurality of dust particles, bacteria and allergens while filtering air that is passed through the air filter, a second filter layer that releases a disinfectant and a fragrance through the air filter into an area where the air passing through the air filter is being directed and a frame that secures the first filter layer and the second filter layer together forming the air filter. The first filter layer, the second filter layer and frame can be made of a variety of materials and fibers that include paper, plastic, metal, natural and synthetic made materials and fibers.

### TECHNICAL FIELD & BACKGROUND

It is common for air in homes and offices to contain a plethora of bacteria and allergens, as well as foul or unpleasant odors. Continuously purchasing items such as air filters to purify the air, and scented candles, plug-ins and the like in order to deodorize an area can be cumbersome and considerably expensive.

The present invention generally relates to an air filter. More specifically, the invention is an air filter with an air freshener.

It is an object of the invention to provide an air filter with an air freshener that serves as a multipurpose filter.

It is an object of the invention to provide an air filter with an air freshener that also includes a fragrance.

What is really needed is an air filter with an air freshener that serves as a multipurpose filter that also includes a fragrance.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front view of an air filter with an air freshener, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

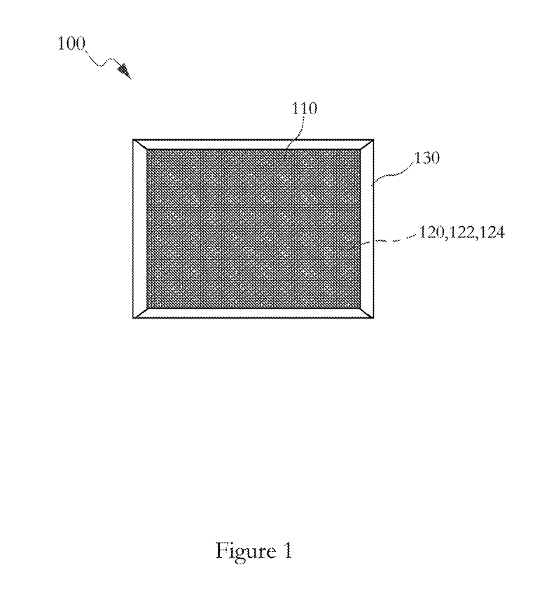

FIG. 1 illustrates a front view of an air filter 100 with an air freshener, according to an embodiment of the present invention.

The air filter 100 includes a first filter layer 110, a second filter layer 120 and a frame 130. The first filter layer 110 catches dust particles, bacteria and allergens while filtering air that is passed through the air filter 100 and can be any type of suitable dust particles, bacteria and allergens filter. The second filter layer 120 releases a disinfectant 122 and a fragrance 124 through the air filter 100 into an area where the air passing through the air filter 100 is being directed. The second filter layer 120 can utilize any suitable disinfectant 122 or fragrance 124. The frame 130 secures the first filter layer 110 and the second filter layer 120 together forming the air filter 100. The frame 130 can secure the first filter layer 110 in front of the second filter layer 120 or the second filter layer 120 in front of the first filter layer 110. Both the first filter layer 110 and/or second filter layer 120 can be made of natural fiber material such as cotton fibers, paper fibers, synthetic fiber material such as plastic fibers or metal fibers or other suitable material. The frame 130 can be made of paper, plastic, metal or any other suitable material.

The air filter is a dual layered filtration system. The first layer of the air filter serves to catch and remove dust particles, bacteria, allergens and other filterable foreign substances in the air that pass through the air filter. The second layer of the air filter emits a fragrance into the air as well as a disinfectant, removing foul or unpleasant odors which may be lingering in the area of the air filter while generating a clean and pleasing aroma. The air filter is available in a variety of sizes and scents to suit the various necessities and preferences of individuals using the air filter. The air filter is practical and safe, and is readily available at retail and home improvement stores. The air filter features a dual layered filtration system capable of not only removing dust particles and other foreign substances from the air, but also deodorizing and disinfecting air that is received and expelled. The air filter is also designed to be installed in the same manner as conventional air filters.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. An air filter, comprising:
a first filter layer that catches a plurality of dust particles, bacteria and allergens while filtering air that is passed through said air filter;
a second filter layer that releases a disinfectant and a fragrance through said air filter into an area where said air passing through said air filter is being directed; and
a frame that secures said first filter layer and said second filter layer together forming said air filter.

2. The filter according to claim 1, wherein said frame secures said first filter layer in front of said second filter layer.

3. The filter according to claim 1, wherein said frame secures said second filter layer in front of said first filter layer.

4. The filter according to claim 1, wherein said first filter layer is made of natural fiber material.

5. The filter according to claim 4, wherein said natural fiber material is paper.

6. The filter according to claim 4, wherein said natural fiber material is cotton.

7. The filter according to claim 1, wherein said first filter layer is made of metal fibers.

8. The filter according to claim 1, wherein said first filter layer is made of synthetic fiber material.

9. The filter according to claim 8, wherein said synthetic fiber material is plastic.

10. The filter according to claim 9, wherein said plastic is polyester.

11. The filter according to claim 1, wherein said second filter layer is made of natural fiber material.

12. The filter according to claim 11, wherein said natural fiber material is paper.

13. The filter according to claim 11, wherein said natural fiber material is cotton.

14. The filter according to claim 1, wherein said second filter layer is made of metal fibers.

15. The filter according to claim 1, wherein said second filter layer is made of synthetic fiber material.

16. The filter according to claim 15, wherein said synthetic fiber material is plastic.

17. The filter according to claim 16, wherein said plastic is polyester.

18. The filter according to claim 1, wherein said frame is made of paper.

19. The filter according to claim 1, wherein said frame is made of plastic.

20. The filter according to claim 1, wherein said frame is made of metal.
